(19) United States
(12) Patent Application Publication
(10) Pub. No.: US 2023/0315862 A1
(43) Pub. Date: Oct. 5, 2023

(54) METHOD AND APPARATUS FOR IDENTIFYING DYNAMICALLY INVOKED COMPUTER CODE USING LITERAL VALUES

(71) Applicant: WHITESOURCE LTD., Givatayim (IL)

(72) Inventors: Aharon ABADI, Givatayim (IL); Bar MAKOVITZKI, Givatayim (IL)

(21) Appl. No.: 17/708,110

(22) Filed: Mar. 30, 2022

(51) Int. Cl. G06F 21/57; G06F 8/75; G06F 8/41

(52) U.S. Cl. CPC G06F 21/577; G06F 8/75; G06F 8/433

(57) ABSTRACT

A method, computerized apparatus and computer program product, the method comprising: obtaining user code; determining whether the code uses a reflection mechanism; subject to the code using reflection mechanism, identifying a reflection-related instruction; identifying at least one possible value for at least one variable affecting execution of the reflection-related instruction; determining code components that comply with the at least one possible value for the at least one literal and are reachable from the reflection-related instruction; and outputting information about the reachable code components.

### TECHNICAL FIELD

The present disclosure relates to statically detecting vulnerability in dynamically loaded code in general, and to a method and apparatus for identifying dynamically invoked computer code, in particular.

### BACKGROUND

Software vulnerabilities are a major cause of a variety of problems, including security problems, privacy violations, financial risks, or any other trouble ranging between mere inconvenience and critical interests including life and death. In particular, security vulnerabilities open a gate to computer hacks, which may cause tremendous damage to the computers and/or to users and clients of the computer systems. By taking advantage of design or implementation flaws, malicious attackers are able to gain access to confidential information available to the target program, take control of the data and use it in a problematic manner. A straight forward example relates to a buffer overflow which can be exploited by attackers to manipulate the software input, overwrite the stack and thus gain control over areas of the code and affect execution of the program.

Some methodologies exist for detecting vulnerabilities, wherein one important distinction is between static and dynamic methods.

Static program analysis is the analysis of computer software performed without executing the program, by only analyzing the computer instructions. Static analysis may refer to the source code or to the object code. Static program analysis sometime uses software metrics and reverse engineering. However, using static analysis does not always enable to determine the dynamic behavior of the code, and in particular when it is unknown which code actually gets executed.

Dynamic analysis, in contrast, may be performed on programs while they are executing. This inherently implies that vulnerability discovery is limited by the coverage of the program, may require a large number of scenarios to be run, but even that cannot guarantee that all vulnerabilities have been discovered.

Yet, with both approaches, debugging code to discover vulnerabilities is a hard task and is an everlasting struggle during the entire development and life cycle of the code.

### BRIEF SUMMARY

One exemplary embodiment of the disclosed subject matter is a computer-implemented method comprising: obtaining code; determining whether the code uses a reflection mechanism; subject to the code using reflection mechanism, identifying a reflection-related instruction; identifying one or more possible values for one or more variables affecting execution of the reflection-related instruction; determining code components that comply with any of the possible value for the variables and are reachable from the reflection-related instruction; and outputting information about the reachable code components. Within the method, the possible values are optionally determined in accordance with a literal assignment. The method can further comprise tracking the code to identify one or more variables affecting the reflection-related instruction, and one or more second variables not affecting the reflection-related instruction. Within the method, tracking the code optionally comprises tracking the code from the reflection-related instruction backwards. The method can further comprise tracking variables within a function or method called by an instruction in which any of the variables is involved. Within the method, reachable code components that comply with the possible values for the variables are optionally components whose name complies with any of the possible values. Within the method, detecting the reflection-related instruction optionally comprises identifying instructions related to a reflection Application Program Interface (API). Within the method, the instructions optionally comprise: an instruction for importing a reflection library; or an instruction for calling a method or component from the reflection library for dynamically exploring a variable. The method can further comprise: using information retrieved from a database, determining that a stored vulnerability is reachable from any of the reachable code components, thereby identifying a potential vulnerability reachable from the user code. The method can further comprise outputting the stored vulnerability. Within the method, a collection of the code and code components and connections therebetween forms a dependency graph. Within the method, a component from the code and code components optionally represents a class, a file, a method, a function, a program component, an interface, or a module. Within the method, a component from the code and code components is optionally to be dynamically loaded for interrogating an entity in run time for getting properties of the entity.

Another exemplary embodiment of the disclosed subject matter is a computerized apparatus having a processor, the processor being adapted to perform the steps of: obtaining code; determining whether the code uses a reflection mechanism; subject to the code using reflection mechanism, identifying a reflection-related instruction; identifying one or more possible values for one or more variables affecting execution of the reflection-related instruction; determining code components that comply with any of the possible value for the variables and are reachable from the reflection-related instruction; and outputting information about the reachable code components. Within the apparatus, the possible values are optionally determined in accordance with a literal assignment. Within the apparatus, the processor is optionally further configured to identify one or more variables affecting the reflection-related instruction, and one or more second variables not affecting the reflection-related instruction. Within the apparatus, tracking the code optionally comprises tracking the code from the reflection-related instruction backwards. Within the apparatus, reachable code components that comply with any of the possible values for the variable are optionally components whose name complies with any of the possible values. Within the apparatus, the processor is optionally further configured to: using information retrieved from a database, determine that at least one stored vulnerability is reachable from at least one of the reachable code components, thereby identifying a potential vulnerability reachable from the user code.

Yet another exemplary embodiment of the disclosed subject matter is a computer program product comprising a computer readable storage medium retaining program instructions, which program instructions when read by a processor, cause the processor to perform a method comprising: obtaining code; determining whether the code uses a reflection mechanism; subject to the code using reflection mechanism, identifying a reflection-related instruction; identifying one or more possible values for one or more variables affecting execution of the reflection-related instruction; determining code components that comply with any of the possible value for the variables and are reachable from the reflection-related instruction; and outputting information about the reachable code components.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart of steps in a method statically generating a dependency graph including dynamically invoked code, in accordance with some exemplary embodiments of the subject matter; and

FIG. 2 is a block diagram of a system for statically generating a dependency graph including dynamically invoked code, in accordance with some exemplary embodiments of the disclosure.

### DETAILED DESCRIPTION

The term “dependency graph” is to be widely construed to cover any data structure representing dependency relationship between methods, functions or other code units within computer code such as a programming project, wherein execution of one unit depends on another unit. In some embodiments, each node or vertex in a dependency graph represents such unit, and an edge from node A to node B represents that the unit represented by node A is dependent on the unit represented by node B.

A call graph is a particular type of dependency graph, which represents the invocation relationship between code units. In some embodiments, an edge from node A to node B represents that the unit represented by node A invokes the unit represented by node B.

The term “literal”, or “literal value”, is to be widely construed to cover any reference to a constant representing a fixed value in source code, such as a constant string, a numerical value or the like. A literal may be assigned to a variable, referred to as a “literal assignment”. “Literal assignment” may be direct, for example a=“hello”, or indirect, for example b=“hello”; c=b.

One technical problem dealt with by the disclosed subject matter relates to discovering vulnerabilities in software code. The problem becomes harder as the software becomes larger and more distributed among various libraries. A human trying to analyze such code and discover vulnerabilities therein cannot possibly thoroughly analyze the complex call chains of methods.

Code reachability analysis of computer code can be utilized to detect reachable code components, since if any such reachable code component contains vulnerabilities, it may pose danger when the computer code is executed. Often, the code may be represented as a dependency graph comprising a collection of nodes and edges, wherein each node represents a code unit, and a directed edge from node f to node g indicates that unit f is dependent upon unit g. Reachable code is identified as a node wherein a path exists from the root of the graph, e.g., a starting point of a program, to the node.

However, using current technologies, static analysis cannot take into account code units such as files, libraries or other components that are loaded dynamically (i.e., at runtime, when the program is executed), since it may not be known prior to runtime which units will be invoked. Moreover, the invoked units may vary between different executions. Thus, such dynamically loaded components may not be analyzed, and vulnerabilities that may be contained in these units or in further units activated by them, and are reachable from the analyzed code, may go undetected.

Dynamic loading of units, i.e., activation in runtime can be performed using a variety of methods, such as inheritance, annotation, or the like. A specific methodology of dynamic loading relates to reflection, which is commonly used by programs that need to introspect their own code. Reflection may be used by reflective Application Program Interface (API) calls. One common use of reflection allows programmers to build string objects at runtime, and invoke a function whose name matches the string. Thus, it is generally unknown which functions will be called in runtime using the generated strings.

It will be appreciated that while the term reflection is used in the programming languages of Java and Phyton, analogous mechanisms exist in other languages, such as calling a dynamically named method in JavaScript. The disclosure is equally applicable to such terms and programming languages.

Some known solutions for tracking reflective API calls are only intra-procedural. Further solutions are unscalable, and are thus impractical for real world programs, due to the many possible literal values that need to be analysed throughout the entire application.

One technical solution of the disclosure comprises identifying situations in which the code, such as Java® code or python® code, imports a reflection library. The existence of such library or other support for the usage of reflection, enables to detect and interrogate classes or other. When such reflection usage is found, one or more nodes or edges between nodes may be added which relate to that code, which is invoked dynamically, for example code that comprises functions or methods having a particular name, or code that implements an interface or extends a class within the invoking code. One or more edges may be added within the dependency graph from the invoking code which loads the invoked code dynamically, to the invoked code, for example between calling code unit and the called unit. It will be appreciated that the invoked code may comprise vulnerabilities, and/or may invoke or call further code, which may comprise vulnerabilities. Thus, the analysis may determine that these vulnerabilities are reachable, such that a user can examine the user's code, the vulnerabilities, assess the risk, take corrective actions, or the like.

In some embodiments of the disclosure, the usage of literals may be tracked, in order to discover methods or functions which correspond to the literal value, and which may be called using dynamic invocation.

Referring now to Listing 1 below, showing an example of such value tracking.

Listing 1

| | |
|---|---|
| i. | class A: |
| ii. | def f1 ( self ): |
| iii. | print ( “A::f1” ) |
| iv. | |
| v. | def f2 ( self ): |
| vi. | print ( “A::f2” ) |
| vii. | |
| viii. | |
| ix. | def reflection (method): |
| x. | a = A( ) |
| xi. | m = getattr (a, method) |
| xii. | m( ) |
| xiii. | |
| xiv. | x = “1” |
| xv. | y = “f” |
| xvi. | z = y + x |
| xvii. | reflection(z) |

A prior art solution, determining only the variable types, would determine the types as shown in Table 1 below:

TABLE 1

| Variable | Type |
|---|---|
| x | String |
| y | String |
| z | String |

By tracking also the values of the variables associated with literals, as instantiated at lines (x) and (xi), the obtained mapping is shown in Table 2 below:

TABLE 2

| Variable | Type and value |
|---|---|
| x | String(”1”) |
| y | String(“f”) |

Following the language's “+” (plus) operator semantics as used at line (xii), variable z can also be mapped to a string, to generate the mapping as shown in Table 3 below:

TABLE 3

| Variable | Type and value |
|---|---|
| x | String(”1”) |
| y | String(“f”) |
| z | String(“f1”) |

With this mapping, the type resolution of variable m within the scope of the method reflection (line viii) is made possible as follows:
The parameter “method” is mapped to String(“f1”) due to the call at line xiii and the fact that z is mapped to String(“f1”).
The call to the constructor A( ) maps the variable “a” to type A.
getattr is recognized as a reflective API call, and examining class A, a method named f1 can be found.

The variable m can be mapped to the method-type A::f1, thus producing the full mapping as shown in Table 4 below:

TABLE 4

| Scope | Variable | Type and value |
|---|---|---|
| A::f1 | self | A |
| A::f2 (unreached) | | |
| reflection | method | String(“f1”) |
| reflection | a | A |
| reflection | m | A::f1 |
| File | x | String(“f”) |
| File | y | String(“1”) |
| File | z | String(“f1”) |

Referring now to Listing 2, which is similar to Listing 1, but wherein object a is created by a call to a function named huge_subprogram, which may take significant time, power and/or computing resources.

Listing 2

| | |
|---|---|
| i. | class A: |
| ii. | def f1 ( self ): |
| iii. | print ( “A::f1” ) |
| iv. | |
| v. | def f2 ( self ): |
| vi. | print ( “A::f2” ) |
| vii. | |
| viii. | |
| ix. | def reflection (method): |
| x. | a = huge_subprogram( ) |
| xi. | m = getattr (a, method) |
| xii. | m( ) |
| xiii. | |
| xiv. | x = “1” |
| xv. | y = “f” |
| xvi. | z = y + x |
| xvii. | reflection(z) |

In this example, assuming that the call to huge_subprogram (line x) returns type A, according to the Class Hierarchy Analysis (CHA), the type inference maps the variable a to type A, without having to analyze huge_subprogram, thereby producing the same output as Table 4 above.

However, this approach of tracking the values of variables associated with literal value assignment, may still waste time and processing power resources, due to the analysis of literals that are not involved in reflective API call, such as the string literals “A::f1” and “A::f2” on lines iii and vi, or any literal within huge_program.

Thus, another technical solution of the disclosure relates to performing type and value inference only for the literals that are involved in reflective API calls. These variables may be identified by backward data flow analysis or backward control flow analysis, both referred to as backward dependency analysis. It will be appreciated that the backward data flow analysis or backward control flow analysis may be interprocedural.

Backward data flow/dependency analysis may start at each reflective API call and track back all variables involved with the call, to determine whether they are associated with a direct or indirect literal assignment. Thus, tracking back from the reflection(z) instruction discovers variable z, which further depends on variables y and x. No further value analysis is required, thereby saving value analysis of lines i to xiii of the shown code, as well as the code within huge_subprogram.

One technical effect of the disclosure provides for determining code dependencies, including resolving dependencies caused by reflection, by performing value inference analysis for literals. The analysis is performed statically, and discovers code segments that are called in runtime using the reflection mechanism. The connected components, i.e., the code segments that can be called may then be checked for known vulnerabilities, thereby discovering possible vulnerabilities of the code.

Another technical effect of the disclosure provides for making the value inference more efficient and thereby scalable, by eliminating from the process variables, literals and assignments that are not involved in any reflection call, including code segments such as functions or methods that are not called.

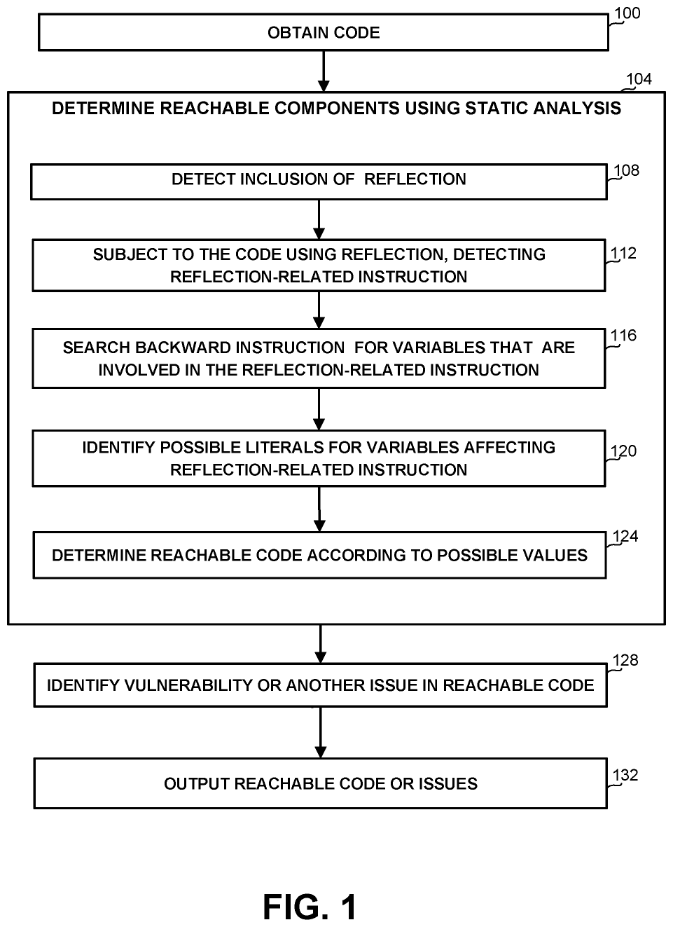

Referring now to FIG. 1, showing a flowchart of steps in a method for identifying computer code invoked dynamically by reflection calls, in accordance with some exemplary embodiments of the disclosure.

On step 100, computer code may be obtained. The code may be obtained in any manner, such as read from a file, transmitted over a communication network, entered by a programmer, being a part of a programming project developed using an Integrated Development Environment (IDE), or the like. The code may be in any programming language, such as but not limited to Python, Java, C, C++, or the like. For example, the code listed in Listing 1 or Listing 2 above may be received. The code may comprise user code and/or external code, such as third-party libraries, open source code, or the like.

On step 104, the collection of reachable code components may be determined using static analysis. Each of the components may be a file, a class, a method, a function, a program component, an interface, a module, or the like. Dependency between components may refer to reachability, file dependency, a usage relationship, or the like. The collection of components and dependencies therebetween may be referred to as a dependency graph, wherein dependency between the components may be determined using any desired method, for example as described in U.S. patent application Ser. No. 16/702,834, filed Dec. 4, 2019, titled “A System and Method for Interprocedural Analysis” and assigned to the same applicant as the current application, incorporated herein by reference in its entirety and for all purposes.

On step 108, the code may be scanned to detect inclusion of a dynamic invocation mechanism. Dynamic invocation may relate to reflection, using dynamic code component loading, or the like. For example, in Java code, the command for importing the reflection library may be: “import java.lang.reflect.Proxy”. The code may be searched by parsing the code and searching for the exact match, or for regular expressions comprising the commands above. The commands may be hardcoded or obtained dynamically when analyzing the program.

On step 112, subject to the detection of the reflection mechanism, reflection-invoking instructions may be searched. For example, an instruction may be detected which calls a method from the reflection library for interrogating an entity in run time for getting properties of the entity.

For example, in Phyton, a reflection invoking instruction may be “getattr” or “_subclass_”.

On step 116, the code may be tracked backwards from the reflection-invoking instructions to identify variables involved in the reflection invoking instruction, wherein the variable values are associated directly or indirectly with literals. Tracking may include scanning the code backwards to preceding commands within the same block, until the beginning of the scope of each variable. Moreover, if instantiating or assigning a value of a literal involves a function or method call, this function or method may need to be tracked as well.

Once tracking is complete, all variables that affect the reflection invoking instruction are identified.

On step 120, the set of possible values that can assigned to these variables, or to all variables if step 116 is omitted, may be identified. The values may be determined in accordance with literal setting, such as a=“1”. Further values may be identified by determining the operations applied to one or more operands for generating the values. For example, in the example above:
x=“1”
y=“f”
z=y+x
assigns the value “f1” to z, since the “+” operator performs concatenation when related to strings.

If the value of a variable is a product of another known operator, the possible values may be calculated. If the operator is unknown, for example is a user-defined operator, all combinations of the operands may be obtained.

It will be appreciated that in some situations, values may comprise regular expressions, such as “f1*”, which covers “f”, “f1”, “f11”, “f111”, etc. In some embodiments, for example if the literals are numbers, the set of possible values may include strings representing a range of numbers, such as “3”-“8”.

In further situations, no information may be available regarding the value of a variable, for example if the value is based on user input, or set in accordance with no literal. In such situations, the value may be set as the regular expression “*”, meaning any string.

On step 124, code components that comply with the one or more possible values for one or more variables associated with the reflection-invoking instructions may be identified. For example, the code components may be those components whose name or another identifier is equal to one of the possible values. In further embodiments, if one of the possible values is a regular expression, compliance may refer to the name or another identifier of the component matching the regular expression.

For example, Class A in Listing 1 above comprises a method f1 corresponding to the value of z being “f1”, therefore this code is reachable, while method f2 is not reachable. If the literal values comprise regular expressions, the available method names are checked for correspondence with the regular expressions.

In some embodiments, if a dependency graph has been created, an edge may be added to the graph for each connection between an identified reachable code and the code that invokes it.

On step 128, the reachable components may be checked for known vulnerabilities or other issues. For example, a database may be searched for a known vulnerability or another issue associated with any of the reachable components.

On step 132, information about the detected vulnerabilities or issues, and/or the components that invoke them may be output, for example provided to a user in a file, over a display device, transmitted over a communication channel, or the like.

It is appreciated that the method of FIG. 1 may be implemented in conjunction with a type inference method, for further analyzing certain types, such as strings. A type inference method may be implemented as disclosed, for example on U.S. patent application Ser. No. 17/325,604, filed May 27, 2021, titled “A System and Method for Interprocedural Analysis” and assigned to the same applicant as the current application, incorporated herein by reference in its entirety and for all purposes.

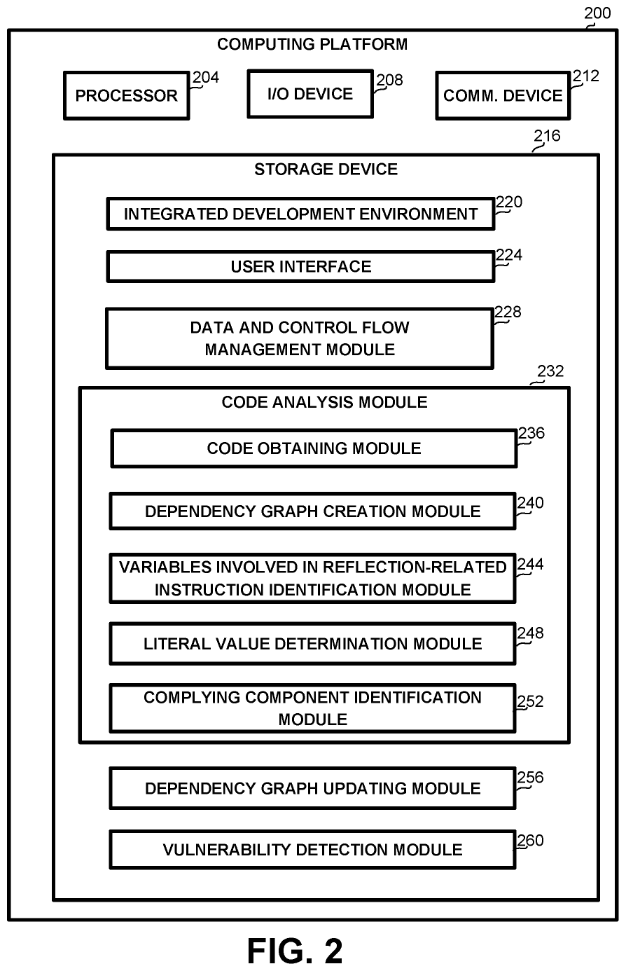

Referring now to FIG. 2 showing a block diagram of a system for identifying computer code invoked dynamically by reflection calls, in accordance with some exemplary embodiments of the disclosure.

The system may comprise one or more computing platforms 200, which may be for example a computing platform used by a developer. The system may be implemented as a stand-alone system, or as part of an Integrated Development Environment (IDE) implemented for example as a plug-in, or the like.

Computing platform 200 may be implemented as two or more interconnected computing platforms. For example some of the modules listed below may be performed by one computing platform, while others may be performed by a different computing platform. In some embodiments, one or more of the computing platforms may be implemented as cloud computers.

In some exemplary embodiments of the disclosed subject matter, computing platform 200 can comprise processor 204. Processor 204 may be any one or more processors such as a Central Processing Unit (CPU), a microprocessor, an electronic circuit, an Integrated Circuit (IC) or the like. Processor 200 may be utilized to perform computations required by the apparatus or any of its subcomponents.

In some exemplary embodiments of the disclosed subject matter, computing platform 200 can comprise an Input/Output (I/O) device 208 such as a display, a pointing device, a keyboard, a touch screen, a microphone, a speakerphone, or the like. I/O device 208 can be utilized to provide output to and receive input from a user. For example, I/O device 208 can display the code, the dependency graph, the detected vulnerabilities, or the like.

Computing platform 200 may comprise a communication device 212 for communicating with other computing platforms or databases, for example computing platforms that implement some of the steps of FIG. 1, one or more databases comprising information about vulnerabilities of libraries such as open source libraries used by the code directly or indirectly, or the like.

Computing platform 200 may comprise a storage device 216. Storage device 216 may be a hard disk drive, a Flash disk, a Random Access Memory (RAM), a memory chip, or the like. In some exemplary embodiments, storage device 216 can retain program code operative to cause processor 204 to perform acts associated with any of the subcomponents of computing platform 200.

Storage device 216 can store the modules detailed below. The modules may be arranged as one or more executable files, dynamic libraries, static libraries, methods, functions, services, or the like, programmed in any programming language and under any computing environment.

Storage device 216 may store a programming development environment (IDE) 220, designed for programming, compiling if required, executing and debugging program code. One or more of the modules below may be implemented as one or more components such as plug-ins for IDE 220, enabling a user to view or examine a dependency graph of the code, receive a vulnerability report, or the like. Alternatively, one or more modules may be implemented as a separate executable which may be invoked by the user, or in any other manner and frequency.

Storage device 216 may store user interface 224 for displaying results to a user or receiving from the user various aspects or parameters associated with the disclosure, such as a displaying a visual representation of the graph, displaying a tabular representation of the graph, displaying the detected vulnerabilities, showing the code with the reflection-related instructions highlighted, showing the values of the literals that affect the reflection-related instructions, or the like.

Storage device 216 can store data and control flow management module 228, for managing the control and data flow of the apparatus, such that modules are invoked at the correct order and with the required information. For example, data and control flow management module 228 can be configured to call vulnerability detection module 260 with the code obtained by code obtaining module 232, and after complying component identification module 252 have finished, and then update the user interface after call vulnerability detection module 260 has been called.

Storage device 212 can store code analysis module 232 for statically analyzing the code, and determining modules that are invoked dynamically, as described in association with FIG. 1 above.

Code analysis module 232 can store code obtaining module 236 for obtaining computer code from a user. The code may be received in any manner, such as read from one or more files, retrieved through a communication channel, or the like. Code obtaining module 236 can also be part of IDE 220 and thus have access to the code. Code obtaining module 236 can be operative in obtaining further code, such as additional projects or files, referenced by the code obtained from the user.

Code analysis module 232 can comprise dependency graph creation module 240, for creating dependency graphs. In a non-limiting example, dependency graph creation module 240 can implement functions for creating a dependency graph from code, adding nodes and edges, or the like. Dependency graph creation module 240 may add all nodes and edges discovered using known technologies, as described above.

Code analysis module 232 can comprise module 244 for identifying reflection-related instructions, for identifying variables involved in the reflection-related instructions, and identifying values of the variables, as created by assignment of literal values.

The reflection-related instructions may be identified using string comparison or regular expression comparison for searching relevant instructions.

Module 244 may identify the relevant variables by applying backward data flow analysis, for tracing backwards from the reflection-related instructions and identifying only the variables that affect these instructions.

Code analysis module 232 can comprise literal value determination module 248 for determining the possible values of the literals that affect the reflection-related instructions. The values may be determined in accordance with literal assignments, or with operators, such as concatenation, that operate on other literals. The literals may thus be assigned absolute values or regular expressions.

Code analysis module 232 can comprise complying component identification module 252, for identifying methods or functions whose names comply with the values (or regular expressions) of the variables associated with the literal assignment.

Storage device 212 can comprise dependency graph updating module 256, for updating the dependency graph created by dependency graph creation module 240, and adding additional edges or additional nodes determined from the code that was realized as reachable by code analysis module 232.

Storage device 212 can comprise vulnerability detection module 260, for detecting vulnerabilities in all reachable code, as represented by the dependency graph as updated by dependency graph updating module 256.

It is noted that the teachings of the presently disclosed subject matter are not bound by the computing platforms described with reference to FIG. 2 and the method of FIG. 1. Equivalent and/or modified functionality can be consolidated or divided in another manner and can be implemented in any appropriate combination of software with firmware and/or hardware and executed on one or more suitable devices. The steps of FIG. 1 can also be divided or consolidated in a different manner.

The system can be a standalone entity, or integrated, fully or partly, with other entities, which can be directly connected thereto or via a network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, JavaScript, NodeJs, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
obtaining code;
determining whether the code uses a reflection mechanism;
subject to the code using reflection mechanism, identifying a reflection-related instruction;
identifying at least one possible value for at least one variable affecting execution of the reflection-related instruction;
determining code components that comply with the at least one possible value for the at least one variable and are reachable from the reflection-related instruction; and
outputting information about the reachable code components.

2. The method of claim 1, wherein the at least one possible value is determined in accordance with a literal assignment.

3. The method of claim 1, further comprising tracking the code to identify the at least one variable affecting the reflection-related instruction, and at least one second variable not affecting the reflection-related instruction.

4. The method of claim 3, wherein tracking the code comprises tracking the code from the reflection-related instruction backwards.

5. The method of claim 3, further comprising tracking variables within a function or method called by an instruction in which the at least one variable is involved.

6. The method of claim 1, wherein reachable code components that comply with the at least one possible value for the at least one variable are components whose name complies with the at least one possible value.

7. The method of claim 1, wherein detecting the reflection-related instruction comprises identifying instructions related to a reflection Application Program Interface (API).

8. The method of claim 5, wherein the instructions comprise:
an instruction for importing a reflection library; or
an instruction for calling a method or component from the reflection library for dynamically exploring a variable.

9. The method of claim 1, further comprising:
using information retrieved from a database, determining that at least one stored vulnerability is reachable from at least one of the reachable code components, thereby identifying a potential vulnerability reachable from the user code.

10. The method of claim 9, further comprising outputting the at least one stored vulnerability.

11. The method of claim 1, wherein a collection of the code and code components and connections therebetween forms a dependency graph.

12. The method of claim 1, wherein at least one component from the code and code components represents a class, a file, a method, a function, a program component, an interface, or a module.

13. The method of claim 1, wherein the at least one component from the code and code components is to be dynamically loaded for interrogating an entity in run time for getting properties of the entity.

14. A computerized apparatus having a processor, the processor being configured to perform the steps of:
obtaining code;
determining whether the code uses a reflection mechanism;
subject to the code using reflection mechanism, identifying a reflection-related instruction;
identifying at least one possible value for at least one variable affecting execution of the reflection-related instruction;
determining code components that comply with the at least one possible value for the at least one literal and are reachable from the reflection-related instruction; and
outputting information about the reachable code components.

15. The apparatus of claim 14, wherein the at least one possible value is determined in accordance with a literal assignment.

16. The apparatus of claim 14, wherein the processor is further configured to identify the at least one variable affecting the reflection-related instruction, and at least one second variable not affecting the reflection-related instruction.

17. The apparatus of claim 14, wherein tracking the code comprises tracking the code from the reflection-related instruction backwards.

18. The apparatus of claim 14, wherein reachable code components that comply with the at least one possible value for the at least one variable are components whose name complies with the at least one possible value.

19. The apparatus of claim 14, wherein the processor is further configured to:
using information retrieved from a database, determine that at least one stored vulnerability is reachable from at least one of the reachable code components, thereby identifying a potential vulnerability reachable from the user code.

20. A computer program product comprising a non-transitory computer readable medium retaining program instructions, which instructions when read by a processor, cause the processor to perform:
obtaining code;
determining whether the code uses a reflection mechanism;
subject to the code using reflection mechanism, identifying a reflection-related instruction;
identifying at least one possible value for at least one variable affecting execution of the reflection-related instruction;
determining code components that comply with the at least one possible value for the at least one literal and are reachable from the reflection-related instruction; and
outputting information about the reachable code components.
